(19) United States
(12) Patent Application Publication
(10) Pub. No.: US 2011/0024998 A1
(43) Pub. Date: Feb. 3, 2011

(54) QUICK RELEASE DEVICE FOR SLEEVE ASSEMBLY

(76) Inventor: YEU-PERNG NIEH, Ta-Li City (TW)

Correspondence Address: PHILLIP LIU, 6980, WHITEOAK DRIVE, RICHMOND, BC, V7E 4Z9, CA

(21) Appl. No.: 12/534,759

(22) Filed: Aug. 3, 2009

(51) Int. Cl. B23B 5/22

(52) U.S. Cl. 279/81

(57) ABSTRACT

A sleeve assembly includes a sleeve having a hexagonal hole and a rectangular hole in two ends thereof and a positioning hole is defined through a wall of the sleeve and communicates with the hexagonal hole. A control member is rotatably mounted to the sleeve and a bead is located between the control member and the sleeve. The bead is movably engaged with the positioning hole. The control member includes multiple first reception portions and second reception portions defined in an inner periphery thereof. The bead is completely received in one of the first reception portions or partially received in one of the second reception portions by rotating the control member. When the bead is completely received in one of the first reception portions, the object in the sleeve drops off from the sleeve.

### FIELD OF THE INVENTION

The present invention relates to a sleeve assembly, and more particularly, to a quick release device for releasing object from a sleeve by rotating a control ring on the sleeve.

### BACKGROUND OF THE INVENTION

A conventional sleeve 10 is shown in FIG. 1 and generally includes a hexagonal hole 101 defined in a first end thereof and a rectangular hole (not shown) defined in a second end of the sleeve 10. The hexagonal hole 101 communicates with the rectangular hole. An annular groove 102 is defined in an outer periphery thereof and a positioning hole 103 is defined through a wall in the annular groove 102 and communicates with the hexagonal hole 101. A bead 15 is engaged with the positioning hole 103. A C-shaped ring 18 is mounted to the annular groove 102 and a gap 180 is defined between two ends of the C-shaped ring 18. A restriction hole 181 is defined through the ring 18 and a portion of the bead 15 is engaged with the restriction hole 181 so that the ring 18 pushes the bead 15 toward the hexagonal hole 101.

When an object is inserted into the hexagonal hole 101, the object pushes the bead 15 to move outward which pushes the ring 18 so that the ring 18 is expanded and the gap 180 is slightly widened. The expanded ring 18 applies a force to the bead 15 to contact against the object. When rotating the sleeve 10 to loosen the object such as a bolt head, the object can be removed with the sleeve 10. The user has to pull the object by the other hand from the sleeve 10. When the object is a nut which is completely received in the sleeve 10, the user then has to use another tool such as a screwdriver or a rod to pick the nut out from the sleeve 10. This not a convenient design to the users and will require extra time.

The present invention intends to provide a quick release device for sleeve assembly and the user simply rotates the control ring to release the object from the sleeve without extra tool needed.

### SUMMARY OF THE INVENTION

The present invention relates to a sleeve assembly which comprises a sleeve having a hexagonal hole and a rectangular hole respectively defined in two ends thereof. A positioning hole is defined through a wall of the sleeve and communicates with the hexagonal hole. A bead is movably engaged with the positioning hole and restricted by a control member rotatably mounted to the sleeve. The control member includes multiple first reception portions and second reception portions defined in an inner periphery thereof. The first reception portions are located alternatively to the second reception portions. The bead is completely received in one of the first reception portions or partially received in one of the second reception portions by rotating the control member.

The primary object of the present invention is to provide a sleeve assembly with a quick release device which is a control ring and rotatably mounted to the sleeve, the object engaged within the sleeve can be released by rotating the control ring without any tool.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a conventional sleeve assembly;

FIG. 2 is a perspective view to show the sleeve assembly of the present invention;

FIG. 3 shows a nut on a threaded rod is engaged with the hexagonal hole in the sleeve assembly of the present invention;

FIG. 4 is a partial cross sectional view to show that the bead is pushed by the second reception portion of the control member of the quick release device of the sleeve assembly of the present invention;

FIG. 5 is a partial cross sectional view to show that the bead is completely received in the first reception portion of the control member of the quick release device so that the object is not biased by the bead;

FIG. 6 is an end cross sectional view of the sleeve assembly in FIG. 4;

FIG. 7 shows that the control member of the quick release device is rotated relative to the sleeve;

FIG. 8 is a partial cross sectional view to show that the bead is completely received in the first reception portion of the control member by rotating the control member;

FIG. 9 shows a guide groove is defined in communication between the first and second reception portions of the control member;

FIG. 10 shows that the first and second reception portions of the control member are through holes, and

FIG. 11 shows that a guide groove is defined in communication between the first and second reception portions in FIG. 10.

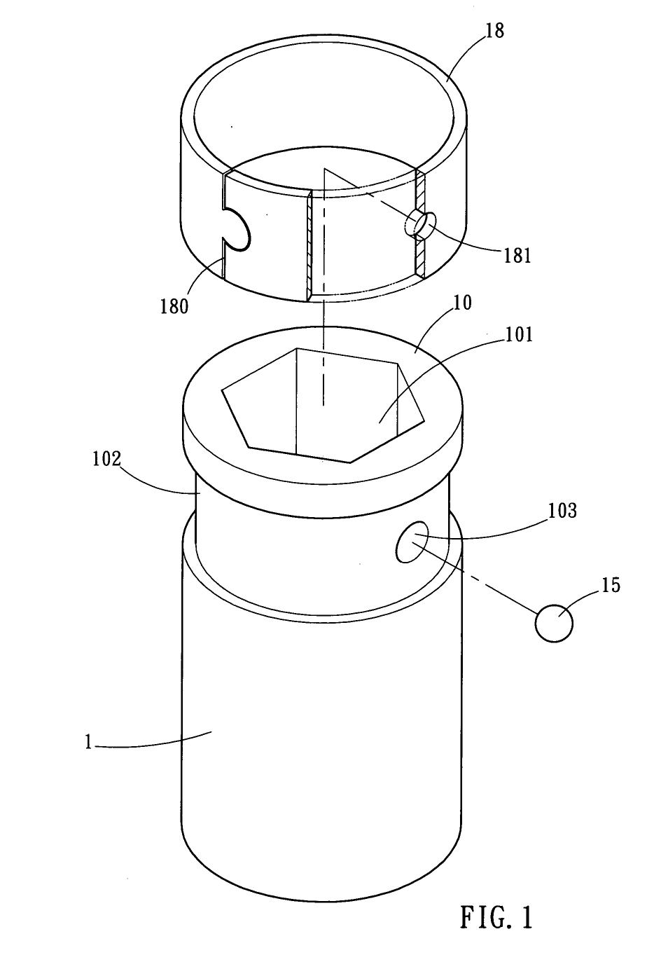

### DETAILED DESCRIPTION OF THE PREFERRED EMBODIMENT

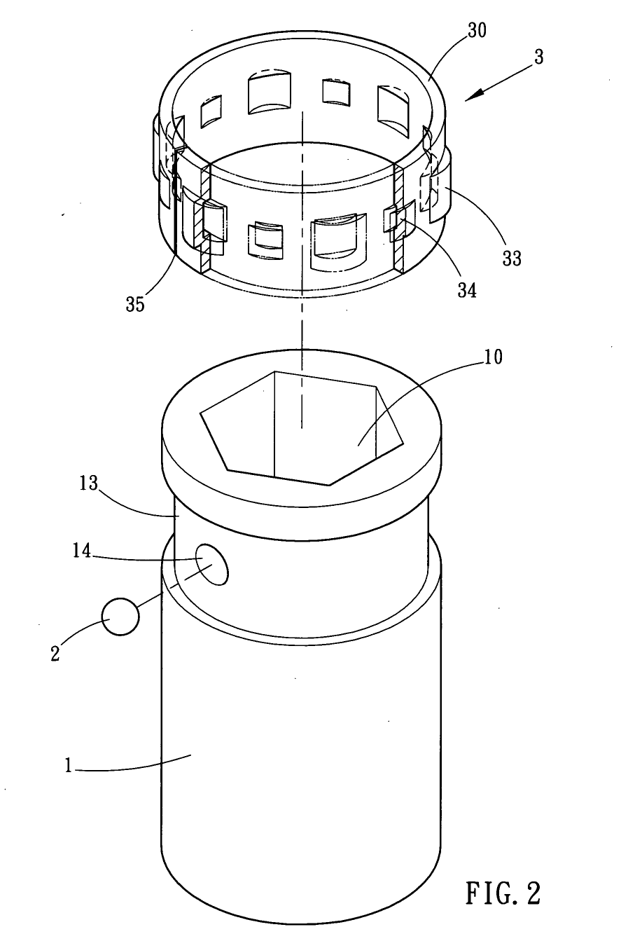

Referring to FIGS. 2 and 3, the sleeve assembly of the present invention comprises a sleeve 1 having a hexagonal hole 10 defined in a first end thereof and a rectangular hole 12 defined in a second end of the sleeve 1. A communication passage 11 is in communication between the hexagonal hole 10 and the rectangular hole 12. The hexagonal hole 10 is for receiving an object such as a bolt head or nut therein and the rectangular hole 12 is for being connected with a driving tool such as a power tool. An annular groove 13 is defined in an outer periphery of the sleeve 1 and a positioning hole 14 is located in an inner wall of the annular groove 13 and defined through a wall of the sleeve 1. The positioning hole 14 communicates with the hexagonal hole 12. A bead 2 is movably engaged with the positioning hole 14. The bead can be replaced by any piece with a rounded end.

A control member 3 rotatably mounted to the sleeve 1 and is a substantially C-shaped ring 30. An inner diameter of the control member 3 is larger than a diameter of the inner wall of the annular groove 13 so that the control member 3 is rotatable relative to the sleeve 1. A gap 35 is defined between two ends of the ring 30. The control member 3 is made of flexible material. Multiple first reception portions 33 and second reception portions 34 are defined in an inner periphery of the control member 3 and the first reception portions 33 are located alternatively to the second reception portions 34. In this embodiment, the first and second reception portions 33, 34 are recesses. Multiple first protrusions and multiple second protrusions extend radially outward from an outer periphery of the control member 3, the first and second protrusions are located corresponding to the first and second reception portions 33, 34. The first reception portions 33 are deeper than those of the second reception portions 34 such that the bead 2 is completely received in one of the first reception portions 33 or partially received in one of the second reception portions 34.

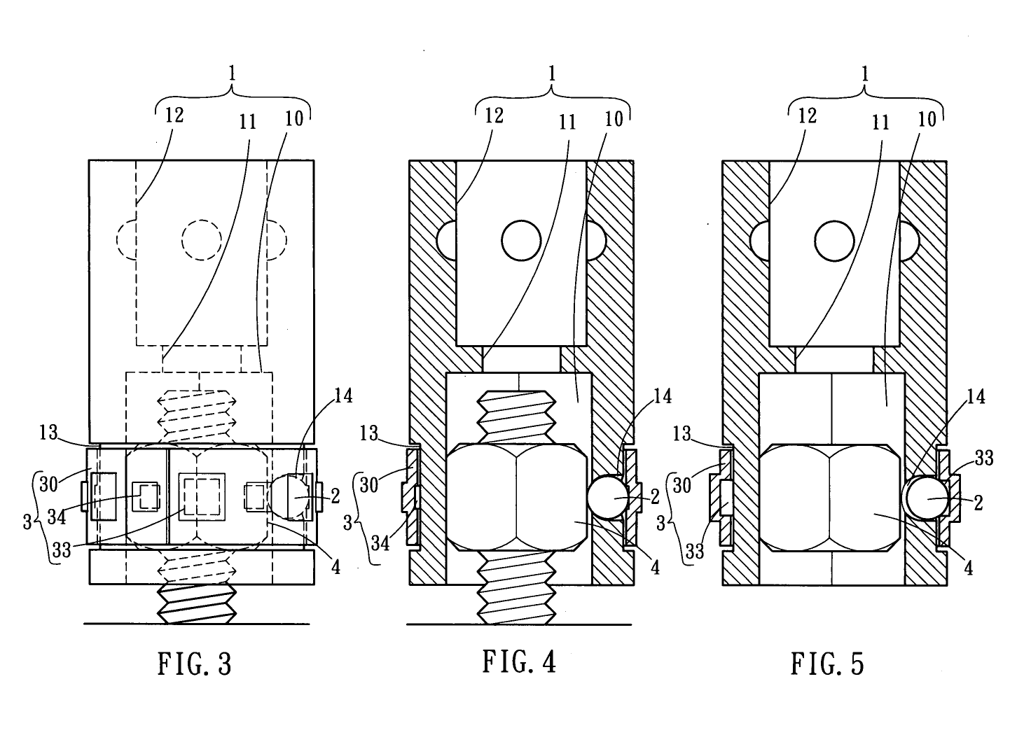

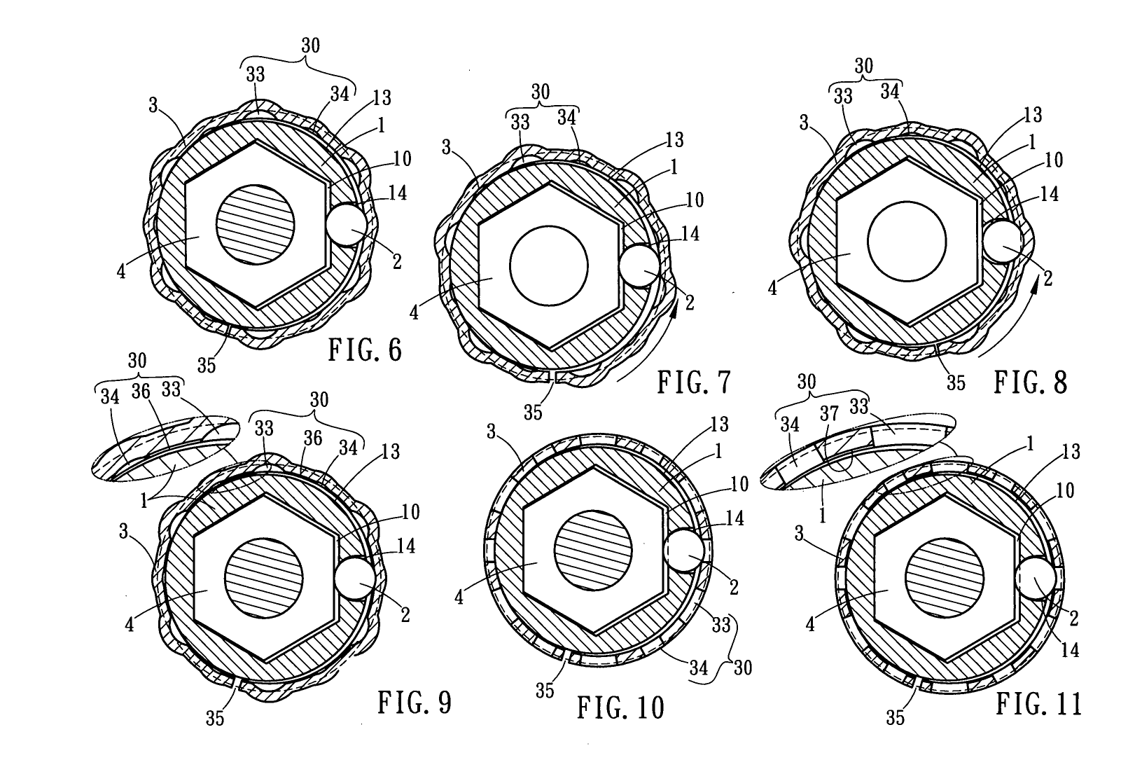

When the sleeve 1 is mounted to a nut 4 threadedly mounted on a threaded rod, the bead 2 is pushed outward by the outside of the nut 4 and the control member 3 is expanded and the bead 2 is pushed by the wall of the second reception portion 34 as shown in FIGS. 4 and 6. Therefore, a force is applied to the nut 4 from the bead 2. When rotating the sleeve 1 to loose the nut 4 from the threaded rod, the sleeve 1 is removed from the threaded rod and the nut 4 is accommodated within the hexagonal hole 10. As shown in FIG. 7, the user rotates the control member 3 so shift the second reception portion 34 away from the bead 2 until the bead 2 is completely received in the first reception portion 33 as shown in FIGS. 5 and 8. The bead 2 no longer applies a force to the nut 4, the nut drops off from the sleeve 1 due to gravity. In other words, the user does not need any tool to remove the nut 4 from the sleeve 1.

As shown in FIG. 10, the first and second reception portions 33, 34 are through holes and the first reception portions 33 are larger than those of the second reception portions 34 such that the bead 2 completely passes through one of the first reception portions 33 or partially engaged with one of the second reception portions 34.

FIG. 9 shows that a guide groove 36 is defined in the inner periphery of the control member 3 and communicates with the first reception portions 33 and the second reception portions 34. The bead 2 is engaged with the guide groove 36 so that when the user rotates the control member 3, less friction is generated.

FIG. 11 shows that a guide groove 37 is defined in the inner periphery of the control member 3 and communicates with the first reception portions 33 and the second reception portions 34 shown in FIG. 10. The bead 2 is engaged with the guide groove 37 so that when the user rotates the control member 3, less friction is generated.

The operation of the control member 2 is easy and effective, the nut 4 can be easily removed from the sleeve 1 by simply rotating the control member 2 so that the user can save a lot of time.

While we have shown and described the embodiment in accordance with the present invention, it should be clear to those skilled in the art that further embodiments may be made without departing from the scope of the present invention.

What is claimed is:

1. A sleeve assembly comprising:
a sleeve having a hexagonal hole defined in a first end thereof and a rectangular hole defined in a second end of the sleeve, a positioning hole defined through a wall of the sleeve and communicating with the hexagonal hole;
a bead movably engaged with the positioning hole, and
a control member rotatably mounted to the sleeve and including multiple first reception portions and second reception portions defined in an inner periphery thereof, the first reception portions located alternatively to the second reception portions, the bead being completely received in one of the first reception portions or partially received in one of the second reception portions by rotating the control member.

2. The sleeve assembly as claimed in claim 1, wherein the first and second reception portions are recesses and multiple first protrusions and multiple second protrusions extend radially outward from an outer periphery of the control member, the first and second protrusions are located corresponding to the first and second reception portions.

3. The sleeve assembly as claimed in claim 2, wherein the first reception portions are deeper than those of the second reception portions such that the bead is completely received in one of the first reception portions or partially received in one of the second reception portions.

4. The sleeve assembly as claimed in claim 2, wherein the first and second reception portions are through holes and the first reception portions are larger than those of the second reception portions such that the bead completely passes through one of the first reception portions or partially engaged with one of the second reception portions.

5. The sleeve assembly as claimed in claim 1, wherein the control member is made of flexible material.

6. The sleeve assembly as claimed in claim 1, wherein an annular groove is defined in an outer periphery of the sleeve and the positioning hole is located in an inner wall of the annular groove.

7. The sleeve assembly as claimed in claim 6, wherein an inner diameter of the control member is larger than a diameter of the inner wall of the annular groove.

8. The sleeve assembly as claimed in claim 1, wherein a communication passage is in communication between the hexagonal hole and the rectangular hole.

9. The sleeve assembly as claimed in claim 1, wherein the control member is a substantially C-shaped ring and a gap is defined between two ends of the ring.

10. The sleeve assembly as claimed in claim 1, wherein a guide groove is defined in the inner periphery of the control member and communicates with the first reception portions and the second reception portions.
